(19) United States
(12) Patent Application Publication
(10) Pub. No.: US 2003/0192412 A1
(43) Pub. Date: Oct. 16, 2003

(54) Device for marking and analyzing defects in a system for cutting boards to size made of wood at least in part

(75) Inventors: Frank Otto, Geretsried (DE); Peter Kryst, Munchen (DE); Joseph Matukewicz, Charlotte, NC (US)

Correspondence Address: WOOD, PHILLIPS, KATZ, CLARK & MORTIMER, Citicorp Center, Suite 3800, 500 West Madison Street, Chicago, IL, 60661-2511, US

(73) Assignee: Siempelkamp Handling Systeme GmbH & Co.

(21) Appl. No.: 10/120,179

(22) Filed: Apr. 10, 2002

(51) Int. Cl. B26D 5/00

(52) U.S. Cl. 83/13; 83/75.5; 83/371

(57) ABSTRACT

The invention relates to a device and a method for marking and analyzing detects in a means for cutting-to-size boards of wood at least in part, in which defect detection is combined with marking by a marking means. By an assignment between the detected defects and marks, the steps in the process following cutting-to-size can be controlled as a function of the existence of defects.

### BACKGROUND OF TH INVENTION

The present invention relates to a device for marking and analyzing defects in a system for cutting boards to size made of wood at least in part.

In this context the term “board” is to be understood very generally, it relating to all board or panel materials involving cutting relatively large sizes as fabricated, into smaller sized pieces for further processing. More particularly, the invention relates to chipboard, OSB, MDF and other fiberboard as well and quite generally to boards of wood, or mainly of wood.

### PRIOR ART

As a rule such boards are fabricated as masterboards, also in endless production, thus requiring subsequent systems for cutting the masterboards to size singly or as books by shears, saws and the like. Cutting to size is dictated by one or more cutting patterns, customized, usually by computer control and optimized to make optimum use of the available masterboard size (pattern optimization). In simpler cases the masterboards are cut to a single size, the cutting pattern thus involving one size type only.

It is often the case that in subsequent processing or prior to stacking and shipping, the cut-to-size pieces are scanned for defects which, for example, may have occured prior to cutting to size in masterboard production. Defective cut-to-size pieces can then be rejected and scrapped. In addition, the cut-to-size pieces can be sorted into various grades, whereby further processing can be made dependent on the quality of the cut-to-size pieces.

### SUMMARY OF THE INVENTION

The objective of the invention is to define means of improving systems for cutting to size boards of wood at least in part as regards board defects.

The invention involves a device for marking and analyzing defects in a system for cutting board to size made of wood at least in part, said device comprising: a defect detection means for scanning the boards for defects; a marking means for applying markings to the boards; a means for cutting the boards into cut-to-size pieces; a means for detecting the marks and a means for controlling a step in a process following mark detection and cutting to size in response to said mark detection and information assigned to said marks as to the existence of defects in the cut-to-size pieces.

The invention further involves a method for marking and analyzing defects in a system for cutting boards to size made of wood at least in part, comprising the steps: scanning the boards in order to detect defects of the boards; applying marks to said boards; cutting said boards into cut-to-size pieces; detecting said marks and controlling a step in a process following detection of said marks and cutting into cut-to-size pieces in response to said detection of said marks and information assigned to said marks as to the existence of defects in said cut-to-size pieces.

Preferred aspects read from the dependent claims and are explained in the following. It is to be noted that the description also discloses a working method implemented by the device and it is understood that the method category is expressly covered by this disclosure.

The invention thus involves a device for marking and analyzing defects for integrating in a system for cutting boards to size. This marking and analyzing device firstly includes a defect detection means for scanning boards for defects. The detect detection means may be a known means preferably working as an ultrasonic or also radiographic system, although of course, other types of defect detection means are conceivable capable of detecting defects relevant to a later step in the process or board quality.

Furthermore, the device in accordance with the invention comprises a marking means, i.e. a device integrated in the machinery for cutting the boards to size and capable of applying marks to the boards in response to a control signal. These marks may be of any kind as will be detailled later, but are required in any case to form information dedicated to the board concerned by the mark. This information can thus be read out at a later point in time as an indication of the existence of defects without the board or the cut-to-size pieces to be produced therefrom needing to be tracked by data processing means via system control. In other words, the mark is intended to ensure that the information can also be recognized even if the boards in being cut to size should become confused or no longer permit individual tracking by system control.

For reading out the marks the device in accordance with the invention comprises a mark detection means adapted to the type of marks applied to the boards, i.e. to the marking means itself, further details of which will be provided later. In conclusion the device in accordance with the invention comprises a means for controlling a downstream step in the process. Controlling the step in the process is required to be a function of detecting the marks and the defects assigned to the marks. In other words, marking the boards serves, after mark detection, to permit control of a step in the process depending on whether defects exist or not.

One salient aspect of the invention involves the marks permitting assignment of information as to the existence of defects to the cut-to-size pieces materializing from the boards. For this purpose this information may be represented in the marks themselves or assigned to the marks by data processing means, the marks needing to be assigned to the cut-to-size pieces in the last case.

Conventionally it was necessary, following detection of defects in the boards, to reject boards as a whole or to downgrade them since it was thought to be impossible to keep track of defects in the device for cutting the pieces to size. Now, by means of the invention the defects can be assigned to the individual cut-to-size pieces by means of the marks in thus making it possible to control a subsequent step in the process as a function of the existence of defects by ways and means related to the individual cut-to-size pieces. This now makes it possible, for example in sorting, to sort out or downgrade cut-to-size pieces having a defect whilst cut-to-size pieces having no defects from a board having defects at other locations can be continued to be treated as first quality.

In addition, the marks in accordance with the invention can also be used to provide additional information as to the defect, for instance as to its severity and effects on later processing or as to the location of the defect within the cut-to-size piece.

One concrete example of a method often employed and preferred in the scope of the present invention for the defect detection means is scanning the boards or cut-to-size pieces ultrasonically. In this arrangement, for example in composite materials, composite defects can be detected by a change in ultrasonic transmission or reflection, similar considerations applying to inclusions, cavities or cracks. One alternative to an ultrasonic system is, for example, a radiographic system. The technical details of defect detection methods suitable for the various types of board are otherwise known to the person skilled in the art and are not essential to appreciating the present invention.

One preferred variant of the downstream step in the process is grading the cut-to-size pieces, as already mentioned, i.e. as a function of the existence and/or severity, nature or other properties of the defects, also otherwise including sorting out cut-to-size pieces in being considered as a grading operation.

The device in accordance with the invention is preferably provided downstream of a board production press preferably designed for continuous or also cycled operation. Such board production presses are particularly suitable for boards consisting at least in part of wood or wood-based material as involved in the invention.

For this purpose it is not necessary that the device in accordance with the invention be directly fitted to the board production press. Although this would be of advantage as regards defect detection by a frequent occurence of defects being detected with minimum delay in thus permitting malfunctioning of the press to be corrected as early as possible, thus making a relativly direct connection of the device to the board production press well conceivable and of advantage. On the other hand, gas contamination or harmful effects due to the heat given off by the press are to be feared in many cases when the device is located too near to the press. Accordingly, a certain spacing is to be maintained in such cases. In this arrangement a so-called diagonal saw can be fitted between the board production press and the device in accordance with the invention for parting the continual stream of boardstock at the output of the press into finite cut-to-size pieces (it needing to be noted in this respect that the term boards, as used in the claims, may also cover the endless stream at the output of the press).

It is particularly in the case of presses for the production of the glued boards that minimizing the amount of glue during pressing is a regular requirement. Furthermore, the press is required to feature a high output speed. Arranging the defect detection means relatively near to the output of the press has the advantage that any wrong setting of the press parameters resulting in a plethora of defects can be recognized with a relatively low waste of time and material. Typical of such defects are bursts or splits in the glued joints within the board which can be detected particularly well by ultrasonic means. Even in a good setting of the press they may occur with a certain statistical frequency in degrading the cut-to-size pieces involved. However, the invention is not restricted to defect detection in boardstock production. Instead, devices in accordance with the invention can be put to use, for example, also following board lamination.

The advantages achieved by the invention are particularly of importance when the marking means marks the boards prior to storage and the mark detection means detects the marks after storage. This may involve, for example, a seasoning storage in which bocks of certain types of board are stacked before being cut to size. It is in this situation that the invention then has the advantage of combining defect detection near in time to board production with control of parts of the device following the storage, i.e. downstream of the storage in the direction of production. For example, after being cut to size the pieces can be combined as a function of sensing the boards still to be cut to size prior to storage whilst avoiding the complications and risks of errors in keeping track of the boards purely by data processing means through the storage. Similar advantages are provided by the invention in an intermediate storage as illustrated in the example embodiment. The intermediate storage serves to decouple stations in a large production plant, the boards as a rule being buffered only for a short length of time. However, it is understood that the above argumentation for the seasoning storage is not basically dependent on the storage time and applies in this case analogously.

However, the invention also finds application, irrespective of intermediate storage, during the production and processing procedures by avoiding more particularly also the complications and susceptibility to error of tracking the cut-to-size pieces by data processing means by systems in which the boards are cut to size in accordance with complex cutting patterns and the various cut-to-size pieces assembled in stack patterns differing from the cutting patterns. Rendering the control compatible with cutting pattern optimization, cutting to size and singling each piece as well as book assembling—where necessary with a change in the sequence of the cut-to-size pieces—already makes for daunting requirements. This is where the invention is of help in avoiding the need to keep track of defects by data processing means individually.

Marking the boards or cut-to-size pieces is preferably done by application of a marking substance. This may be an ink or a dye applied by a spray means, an ink jet printer, or the like, or it may also be a label to be applied. The marking substance must riot necessary permit reading in the visible range. It may also involve a mark for reading by a invisible beam, for instance a mark recognizable only by a beam of ultraviolet light. This may be of advantage because the visual finish of the cut-to-size pieces is not marred by the mark. However, a visible mark applied with a dye may be configured so small or so unobtrusive that it is substantially not a nuisance. Apart from this, it is not always the case that the surfaces of cut-to-size pieces are subject to high demands on visual appeal, for instance when intended for subsequent laminating or sanding.

The mark detection means is preferably an optical system for detecting the marking substance and may, for example, be a video camera which may be equipped, where necessary, with illumination in a suitable wavelength range or a corresponding sensitivity in the suitable wavelength range.

When the cut-to-size pieces or boards are to be sanded, such marks could become lost in sanding. Preferably the sander is then provided downstream of a storage facility so that the mark detection means can be provided upstream of the sander. The means for controlling the device in accordance with the invention can, after detection of the marks, keep track of the cut-to-size pieces or boards by data processing means through the sander to permit suitable control of downstream steps in the process, for instance sorting.

In one preferred embodiment of the invention the marking means is designed to mark the boards for cutting to size, i.e. by dividing the marks on the boards so that they are assigned to the correct cutting to size locations. This does not necessarily mean that all cut-to-size pieces need to be marked. Instead, in one preferred variant the defect detection means is designed to scan the boards even before marking and to furnish a control signal to the marking means so that the marking means is able to mark the boards in response to this control signal. Preferably the marking means then marks the boards only at cut-to-size pieces having defects or only at cut-to-size pieces having no defects, although of course it is just as possible that all cut-to-size pieces are marked in this embodiment. In the last case, however, because information as to the defects already exists in the control signal, the information as to the existence and possibly also further information as to the defects is preferably contained in the marks.

In one particularly preferred embodiment the marks are otherwise applied to the defects themslves or in their immediate vicinity in thus being locally assigned to the defects and thus of course also (only) to each of the cut-to-size pieces having defects. Reference is made to the example embodiments.

However, the marks on the cut-to-size pieces may also serve simply to distinguish the cut-to-size pieces so that then by data processing ways and means, i.e. illustratively in an assignment table, the individual marks or the cut-to-size pieces can be linked to the information as to the existence of any further information as to the defects. In this variant it is not necessary that the defect detection means is arranged upstream of the marking means, although it is just as conceivable to apply distinguishable code markings on the boards but not throughout on each and every cut-to-size piece. An assignment file can then link information as to the defects contained in a board to the code marking of the board. This embodiment is comparable to marking the boards with marks representing location coordinates as already aforementioned with the difference, however, that in this case the code marking merely individualizes the board whilst still yet to furnish information as to the defects.

A further embodiment of the invention relates to marks furnishing location coordinates of the defects. For one thing, such marks can be applied to the board without providing marks on each of the cut-to-size pieces. In this case the mark detection means should be provided upstream of the cutting to size means to generate from the coordinates obtained from reading out the marks a corresponding signal for keeping track by data processing means of the defects in the further course of the process. In this arrangement the information as to the defects, as intended by the invention, is linked to the board, for example, during intermediate storage. It is, however, just as conceivable in such a variant to provide the mark detection means upstream of the cutting to size means, for instance when the mark with the location coordinates is provided in each case with the first cut-to-size piece attaining the mark detection means after having been cut to size in then obtaining the information as to the defects of the subsequent cut-to-size pieces.

Marks with information as to the location coordinates may however also be applied in a local assignment, as already described in another context, to the cut-to-size pieces on the boards. Then, for example, only the cut-to-size pieces actually defective could be marked in the board. For sorting the cut-to-size pieces such marks are then—apart from any other information as may be provided—of no concern, although they may be of assistance, however, in further processing defective cut-to-size pieces subsequent to sorting, for instance when these are to be further substantially-divided in then parting out the defects in accordance with the location coordinates.

### BRIEF DESCRIPTION OF THE FIGURES

FIG. 1 is an overview illustration of a device in accordance with the invention at the output of a board production press in a plan view.

FIG. 2 is a detail taken from FIG. 1 on a magnified scale.

FIG. 3 in a detail taken from FIG. 2 in a side view in accordance with the arrows A-A in FIG. 1.

FIG. 4 is a diagrammatic view of a board with defects and marks in accordance with a first embodiment.

FIG. 5 is a diagrammatic view of a board with defects and marks in accordance with a second embodiment.

FIG. 6 is a diagrammatic view of a board with defects and marks in accordance with a third embodiment.

FIG. 7 is a diagrammatic view of a board with defects and marks in accordance with a fourth embodiment.

### DESCRIPTION OF EXAMPLE EMBODIMENTS

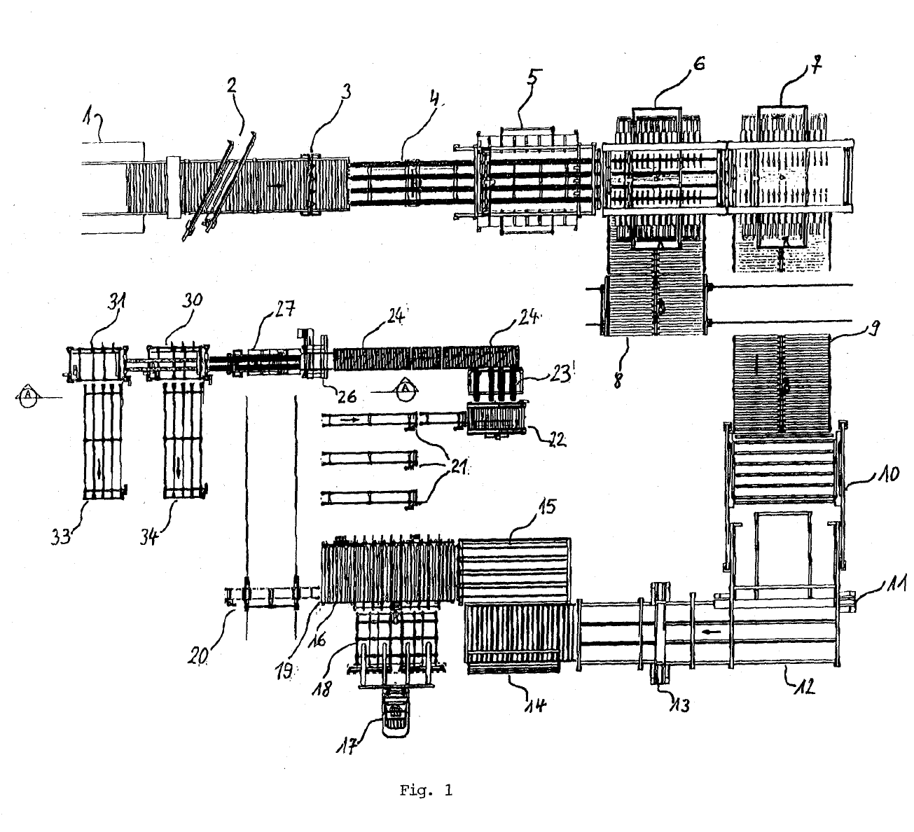

Referring now to FIG. 1 there is illustrated in the upper portion on the left a conventional continual board production press 1 for OSB production. At the output thereof working in the direction of production from left to right is a roll stand unessential to the invention and only required for press downtime, as well as a conventional double diagonal saw 2. The double diagonal saw 2 parts a continuous stream of boardstock furnished by the board production press 1 by cross-cuts into masterboards. Due to the diagonal arrangement the saw blade can be included in the movement of the boardstock.

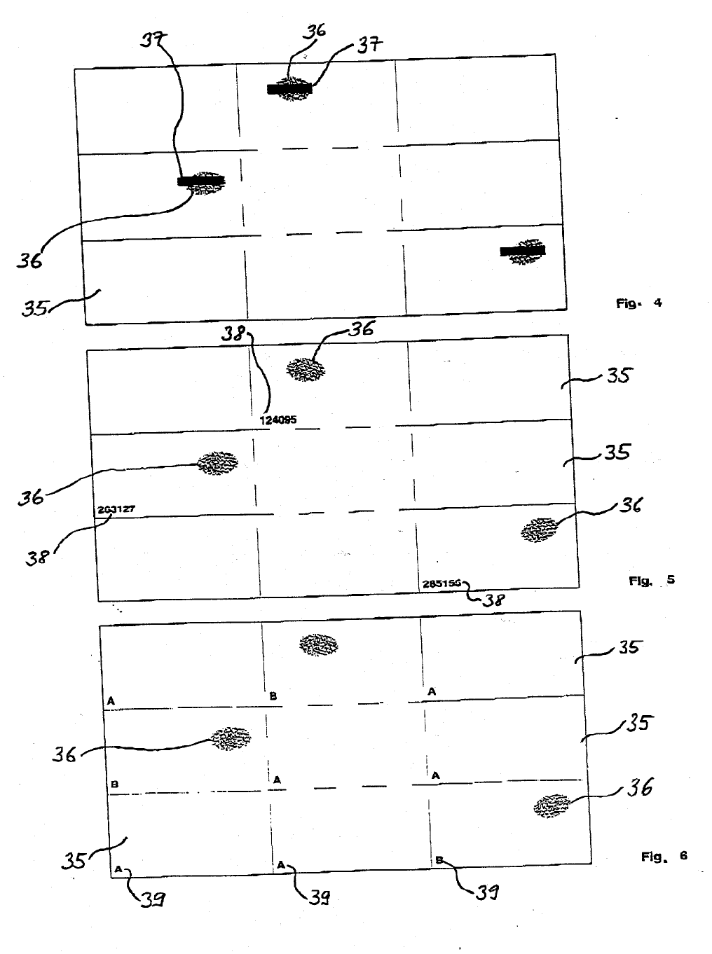

The boards cut-to-length by the double diagonal saw 2 are conveyed from the board production press 1 through the saw 2 by a roller conveyor which guides the boards cut-to-length to a portal-type configured means 3. The means 3 is a combination of a defect detection means which scans the transmission of the boards via a plurality of ultrasonic emitters and ultrasonic detectors located juxtaposed in the width direction of the boards and thus providing indications as to the defects in the glueing of the OSB production. At the same time the defect detection and marking means 3 is combined with a marking means which applies a visible ink mark to spot a detected defect. The ink mark is assigned in location to the defect, i.e. in the plane of the board, and thus in the plane of the drawing as shown in FIG. 1. Reference is made to the description of FIG. 4 for more details.

The defect detection and marking means 3 is followed by a conveyor section 4 serving as a weigher in replacing the aforementioned roller conveyor by a belt conveyor (indicated symbolized by the black stripes in FIG. 1) Weighing the boards cut-to-length is prior art and usual

This is followed by a reject station 5 likewise equipped with a belt conveyor for permitting rejection of scrap boards on the conveeyor by conventional ways and means, as may be the case for obvious defects as visual to the operator as well as for a plethora of defects as detected by the defect detection means 3.

From the reject station 5 the non-rejected boards are further conveyed to two stacking bins 6 and 7 in sequence. The stacking bins 6 and 7 serve to stack the boards sorted. In this example, second-grade boards, i.e. those having at least one detected and marked defect are stacked in the stacking bin 6, whereas zero-defect boards are run through the stacking bin 6 for stacking in the stacking bin 7. In this arrangement, stacking is done by placing the boards on a stacking bin base or a stack already commenced whose top edge is below the level of the conveyor leading from the board production press 1 to the stacking bin 6. The stacking bin 6 features a belt tipple adjoining this conveyor, here again indicated symbolized by the black stripes in FIG. 1 and movable in the vertical direction in thus enabling it to be added to the conveyor coming from the reject station 5 for moving the boards through stacking bin 6 to stacking bin 7 where they are stacked. By a vertical upwards movement the belt tipple can be removed from the movement range of the boards in the stacking bin 6 so that the boards can be stacked in the stacking bin 6.

Finished stacks in the stacking bins 6 and 7 are run out sideways (downwards as shown in FIG. 1) by a roller conveyor system, a rail car transfer cart 8 including a roller conveyor discharging the finished stacks from the stacking bin 6 as well as the finished stacks from the stacking bin 7.

At this location in the system a storage (not shown) is provided in FIG. 1. This storage serves to buffer the stacked boards prior to further processing. The storage is served by the rail-guided transfer cart 8 and conveying means (not shown) which moves the stacks of boards from the storage so that they can be brought by the rail-guided transfer cart 8 with the roller conveyor to a roller conveyor section 9. They may be applications, however, in which no storage is provided and the stacks of boards brought directly to the roller conveyor section 9.

In FIG. 1 the roller conveyor section 9 is indicated in a connection to the stacking bins 6 and 7 with direct communication via the travelling transfer cart 8, although in a practical version the roller conveyor section 9 may also be remote from the stacking bins 6 and 7 and served by some other means of conveyance. The roller conveyor section 9 transports the stacks of boards to a board feeder 10 at which the stacks are destacked and restacked into smaller stacks termed books. These books comprise a small number of boards each stacked vertically on the other and are slit (relative to the board size) by a first saw 11 in ways and means known as such, before being changed in direction in a transfer corner station 12 and cross-cut in a second saw 13. In this arrangement a complex cutting pattern may be achieved, where necessary. In the preseent case, however, the boards are cut to size stacked uniformly and in a checkerboard arrangement.

Reference numerals 14 and 15 identify a stacking bin adjoining the conveyor coming from the second saw 13. This stacking bin has a conventionally configuration, it consisting substantially of a rake-type cart identified by reference numeral 14 for lifting the boards already cut to size as supplied by the conveyor fully, i.e. in accordance with the board size and stacking on the station 15 provided with a chain conveyor. For this purpose the divided boards are swept from the rake-type cart 14. The stacking bin 14, 15 thus forms on the station 15 a stack height of for example 80-100 cm which is significantly more than the book height generated at the board feeder 10. In this arrangement the cut-to-size pieces are still located juxtaposed so that, in all, the board shape is maintained.

As soon as a finished stack has materialized at the station 15, the stack is ejected via the aforementioned chain conveyor in FIG. 1 to the left into a station 16 including a roller conveyor so that station 15 is then free for assembly of the next stack.

Should trouble occur in the downstream stations of the system as a whole a forklift identified 17 is able to remove the stack via an emergency out-deck 18 in thus enabling a temporary interruption in conveyance at a downstream station to be bridged without having to halt upstream components of the system. In addition to the aforementioned rollers, station 16 is also equipped with chains 18 for lifting and lowering between the rollers. These chains are additionally provided with mounting pads over part of the length serving to convey the cut-to-size pieces transversely to the conveying direction dicatated by the rollers of station 16. This permits separation of the cut-to-size pieces into strips having the original length dimension of the board but of reduced transverse dimension in thus producing longitudinal strips of cut-to-size pieces in sequence lengtthwise. For this purpose the mounting pads are travelled under the cut-to-size pieces of each strip and then lifted in being moved with the cut-to-size pieces of the strip located thereon away from the remaining cut-to-size pieces.

Via the rollers of the station 16 the strips can then be travelled to the left as shown in FIG. 1 to a reference line 19. At the reference line 19 the strips can be transferred either completely or by a further separating process relative to the reference line 19 between cut-to-size pieces of the strips to a rail-guided transfer cart 20. This transfer cart 20 is able to receive a complete strip, it serving to move the strips of cut-to-size pieces to an intermediate storage identified in all by reference numeral 21 where the cut-to-size pieces are buffered. This intermediate storage serves, similar to the non-identified storage interposed between the parts 8 and 9 of the system, to temporarily decouple production between the various parts of the system. In addition, zero-defect cut-to-size pieces can be transferred by ways and means not indicated, from the left-hand end of the cart 20 in its location as shown in FIG. 1 to a packaging line where they are directly packaged and shipped. This may be practical when a stack of boards coming from the stacking bin 7 requires further processing, i.e., when only zero-defect cut-to-size pieces are anticipated in any case. When, on the other hand, a stack of boards coming from the stacking bins 6 require further processing, i.e. because of the boards, and thus some of the cut-to-size pieces, having defects, the cart 21 serves to supply the cut-to-size pieces to a regrading line.

From the intermediate storage 21 the cut-to-size pieces or strips thereof are transferred to a feeder station 22. The feeder station 22 comprises a lifting platform with conveying rollers serving to bring the top edge of each stack of cut-to-size pieces to a specific level from which the topmost layer of cut-to-size pieces can be swept off to a belt conveyor section 23. The belt conveyor section 23 merely serves to bridge the distance in conveying the newly arriving cut-to-size pieces to a roller conveyor 24.

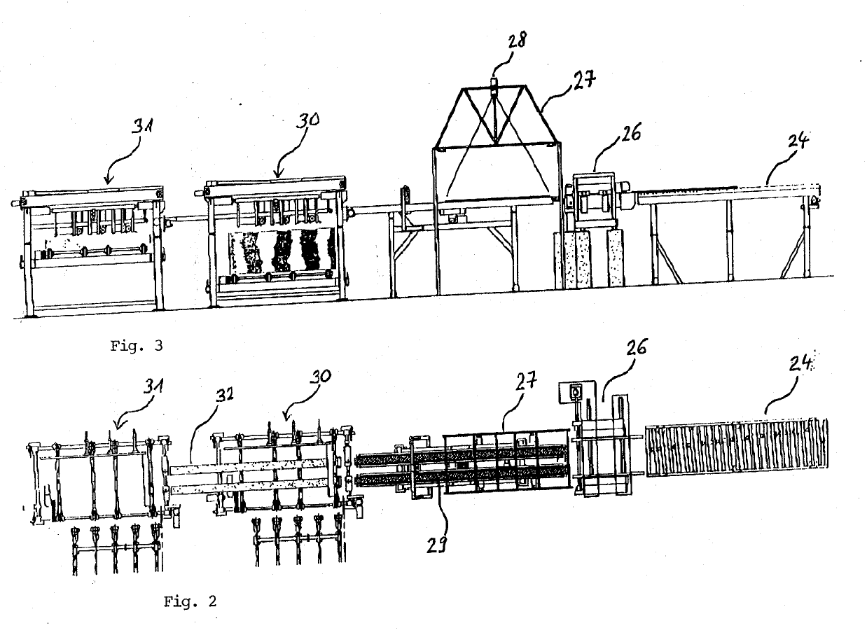

Referring now to FIG. 2 and FIG. 3 there is illustrated how the individual cut-to-size pieces are then forwarded by a roller conveyor 24 evident on the right to a conventional device 26 for tongue-and-groove molding. Adjoining this device is a mark detection means 27 comprising a video camera 28. As evident from FIG. 3 (corresponding to the side view as indicated by the arrows A-A in FIG. 1) the site of the mark detection means 27 is monitored by means of the video camera 28 in optically detecting the marks applied by the defect detection and marking means 3. In the mark detection means 28 the cut-to-size pieces are conveyed by a belt conveyor 29 which removes them from the mark detection means 27 to the left as shown in the Figures and forwards them to two stacking bins 30 and 31 in series. This bins serve to stack the cut-to-size pieces sorted in accordance with a mark and thus a defect having been detected by the mark detection means 28. Defective cut-to-size pieces are forwarded through the stacking bins 30 by a tipple belt conveyor 32 and stacked in the bin 31 whereas zero-defect cut-to-size pieces have already been stacked at the stacking bin 30. The configuration of the stacking bins 30 and 31 may be otherwise conventionally in corresponding to the stacking bins 6 and 7 except for the format stackable.

The stacks of cut-to-size piece produced in the stacking bins 30 and 31 are graded and can be moved out of the system by the conveyor means 33 and 34.

Otherwise, the mark detection means 27, for example, could also be located upstream of the device 26 or roller conveyor 24. In this example embodiment the only deciding issue is that the cut-to-size pieces enter the mark detection means 27 in single layers for distinguishing defective and zero-defect cut-to-size pieces. In another possibility, a sanding means, for example, could be interposed between the stacking bins 30 and 31 and the mark detection means 27. In this case, after being detected by the mark detection means 27 the defective cut-to-size pieces would have to be kept track of by the data processing means up to their stacking bins 30 and 31 which would not involve any further problems since the cut-to-size pieces already occur separated at this location and no longer need regrading.

Thus, the invention now makes it possible to avoid, on the other hand, the difficulties as would be involved in keeping track of the individual boards and cut-to-size pieces therein through the storage by data processing means, and, on the other, also the difficulties materializing from keeping track of the detected defects by cutting the boards into cut-to-size pieces and separating the cut-to-size pieces. At the same time, however, the defect detection and marking means 3 can be arranged relatively near to the output of the board production press 1, as desired in thus permitting fast halting of production in the press should a plethora of defects occur.

The example embodiment thus permits sorting in the stacking bins 30 and 31 without needing to provide a data processing means connected to the defect detection and marking means 3. All that is needed is a control of the stacking bin 30, i.e. its belt conveyor 32 by the directly adjoining mark detection means 27.

Referring now co FIG. 4 there is illustrated the aforementioned board marking wherein the individual cut-to-size pieces are identified by the reference numeral 35 separate from each other by partly broken lines. FIG. 4 shows however a board still to be sawed after marking go that the parting lines between the cut-to-size pieces 35 merely represent the cutting pattern to be achieved by the saws 11 and 13. Reference numeral 36 identifies board defects indicated shaded in some of the cut-to-size pieces 35. The defect detection and marking means 3 detects these defects 36 by ultrasonic scanning and marks with ink spots 37 represented by the black stripes in FIG. 4. In this arrangement, the ink spots 37 are locally assigned to the defects 36, i.e. it not being needed to already know how the board is to be sawed into the cut-to-size pieces 35 and thus correspondingly simplifying the example embodiment as shown in FIGS. 1-3.

Referring now to FIG. 5 there is illustrated an alternative thereto whereby the board with its cutting to size configuration and defects 36 corresponding to that as shown in FIG. 4. In this case, however, instead of the ink spots 37 local assigned to the defects 36, digital code marks 38 are provided assigned, on the other hand to the cut-to-size pieces 35, but not to the defect 36, and on the other are provided only on cut-to-size pieces 35 actually exhibiting a defect 36. In addition the digital code marks as shown in FIG. 5 are intended to represent the location coordinates of each defect 36 within each cut-to-size piece 35 concerned. For example, the first three digits of the six-digit number shown may symbolize an X coordinate (horizontal in FIG. 5) and the last three digits an Y coordinate (perpendicular in FIG. 5) in each relating to a centerpoint of the defect 36. This enables the mark detection means 27 to “see” the existence of a defect 36 from the existence of a mark 38. In other words, it is sufficient for sorting to the stacking bins 30 and 31 when the existence of the marks is recognized in the mark detection means 27. In subsequent further processing of the defective cut-to-size pieces 35 (not shown in FIG. 1) these cut-to-size pieces 35 could be divided, for example, into even smaller cut-to-size pieces, whereby in making use of the information as to the defect coordinates the corresponding site can be skipped. In this arrangement, however, the defect coordinates may also contain information as to the extent of the defects. In FIG. 5 it was assumed that the typical defects are roughly equal in size.

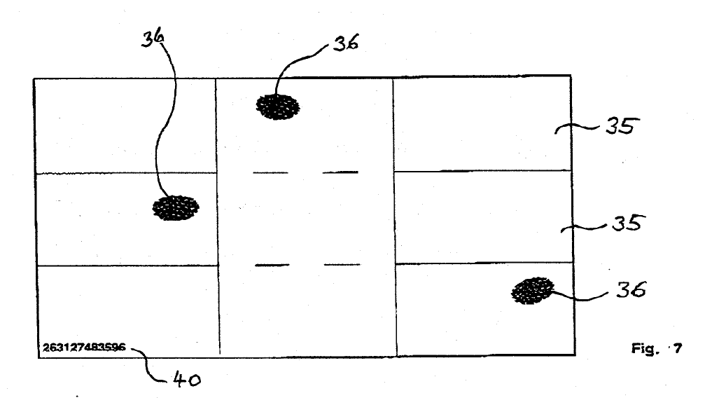

Referring now to FIG. 6 there is illustrated in turn a board corresponding to that as shown, in FIGS. 4 and 5 having a corresponding cutting to size configuration and corresponding defects 36 in a further example embodiment. In this case the individual cut-to-size places 35 each feature marks 39 provided at each cut-to-size piece 35 but not assigned local to the defects 36. The type of the marks involved differ, depending on the existence of the defects thus, in FIG. 6 the defective cut-to-size pieces 35 are identified B whilst the zero-defect cut-to-size pieces 35 are identified A, whereby, of course, use may be made of different colors, defect shapes and sizes or other distinguishing features.

The example embodiment as shown in FIG. 6 may also be visualized by each cut-to-size piece 35 having a different mark so that the cut-to-size pieces 35 can be distinguished from each other. For example, they could feature instead of marks A and B a continuous sequence of digits continuing also from board to board and recommencing with the digits as used before only after a larger number of boards. This enables the data as to which cut-to-size pieces 35 featuring which defects 36 to be stored in an assignment file.

For the example embodiments as shown in FIGS. 5 and 6 as wall as for the variant as just discussed with reference to FIG. 6 it is necessary in each case that the defect detection and marking means 3 take into account the cutting pattern in producing the mark so that the marks 38, 39 can each be locally assigned to the cut-to-size pieces 35. This is very simple technically in the case of the cutting pattern as used being simple and consistent, whereas for more complex and inconsistent cutting patterns suitable information needs to be sent to the defect detection and marking means 3.

Referring now to FIG. 7 there is illustrated in conclusion an example embodiment similar to that as shown in FIG. 5 in which a mark 40 features the coordinates of the defects 36. In this case, however, the mark 40 is applied in a dedicated position to the board and not assigned locally to the individual cut-to-size pieces 35. The mark 40 thus features the coordinate information as to all defects 36 occuring on this board. In this example embodiment the mark detection means 27 would have to be located upstream of the cutting to size saws 11 and 13, after which the individual cut-to-size pieces 35 are kept track of by data processing means. By means of the defect coordinates represented in the mark 40 and the cutting pattern it is easy to establish which cut-to-size pieces are defective. Furthermore, the mark 40 may also contain information supplementary to the defect coordinates in this example embodiment.

1. A device for marking and analyzing defects in a system for cutting boards to size made of wood at least in part, comprising:
a defect detection means for scanning the boards for defects;
a marking means for applying marks to said boards;
a means for cutting said boards into cut-to-size pieces;
a means for detecting said marks and
a means for controlling a step in a process following detection of said marks and cutting into cut-to-size pieces in response to said detection of said marks and information assigned to said marks as to the existence of defects in said cut-to-size pieces.

2. The device as set forth in claim 1 wherein said defect detection means works by an ultrasonic method.

3. The device as set forth in claim 1 wherein said detect detection means works by a radiographic method.

4. The device as set forth in claim 1 comprising a means for sorting said cut-to-size pieces in response to said detection of said marks.

5. The device as set forth in claim 1 incorporated downstream in the direction of production of a board production press.

6. The device as set forth in claim 1 wherein said marking means is incorporated, upstream of a storage in the direction of production and said mark detection means is incorporated downstream of said storage in the direction of production.

7. The device as set forth in claim 1 wherein said marking means is designed to apply a marking substance to said boards.

8. The device as set forth in claim 7 wherein said mark detection means is an optical system for detecting said marking substance.

9. The device as set forth in claim 1 wherein said marking means is designed to mark said boards at said cut-to-size pieces.

10. The device as set forth in claim 9 wherein said defect detection means is designed to scan said boards prior to marking and to supply a control signal to said marking means is and said marking means is designed to mark said boards only at cut-to-size pieces having defects.

11. The device as set forth in claim 10 wherein said marks are locally assigned to said defects.

12. The device as set forth in claim 9 wherein said marks are applied to all cut-to-size pieces and contain information as to the existence of defects in each case.

13. The device as set forth in claim 1 wherein said defect detection means is designed to scan said boards prior to marking and to supply a control signal to said marking means and said marking means is designed to apply marks to said boards containing location coordinates of said defects.

14. The device as set forth in claim 13 wherein said marks are locally assigned to said cut-to-size pieces.

15. The device as set forth in claim 1 wherein said marking means is designed to apply to said boards code markings each distinguishable from the other so that said control means can be supplied with files containing assignments between said defects and said code markings.

16. The device as set forth in claim 15 wherein said marks are locally assigned to said cut-to-size pieces in enabling said cut-to-size pieces to be distinguished from each others.

17. A method for marking and analyzing defects in a system for cutting boards to size made of wood at least in part, comprising the steps:
scanning the boards in order to detect defects of the boards;
applying marks to said boards;
cutting said boards into cut-to-size pieces;
detecting said marks and
controlling a step in a process following detection of said marks and cutting into cut-to-size pieces in response to said detection of said marks and information assigned to said marks as to the existence of defects in said cut-to-size pieces.

18. The method as set forth in claim 17 wherein said defects are detected by an ultrasonic method.

19. The method as set forth in claim 17 wherein said defects are detected by a radiographic method.

20. The method as set forth in claim 17 comprising the steps of sorting said cut-to-size pieces in response to said detection of said marks.

21. The method as set forth in claim 17 being applied downstream in the direction of production of a board production press.

22. The method as set forth in claim 17 wherein said marking step is applied upstream of a storage in the direction of production and said mark detection is applied downstream of said storage in the direction of production.

23. The method as set forth in claim 17 wherein a marking substance is applied to said boards in said marking steps.

24. The method as set forth in claim 23 wherein said mark detection is optical.

25. The method as set forth in claim 17 wherein said boards are marked at said cut-to-size pieces.

26. The method as set forth in claim 25 wherein said boards are scanned prior to marking in order to detect defects and a control signal is produced in order to mark said boards only at cut-to-size pieces having defects.

27. The method as set forth in claim 26 wherein said boards are marked locally at said defects.

28. The method as set forth in claim 27 wherein all cut-to-size pieces are marked and sand marks contain information as to the existence of defects in each case.

29. The method as set forth in claim 25 wherein said boards are scanned prior to marking in order to detect defects and a control signal is produced in order that said marks contain location coordinates of said defects.

30. The method as set forth in claim 29 wherein said boards are marked locally at said cut-to-size pieces.

31. The method as set forth in claim 17 wherein said boards are marked with code markings each distinguishable from the other so that files containing assignments between said defects and said code markings can be produced and used for controlling.

32. The method as set forth in claim 31 wherein said boards are marked locally at said cut-to-size-pieces in enabling said cut-to-size pieces to be distinguished from each other.
